(19) United States
(12) Patent Application Publication
(10) Pub. No.: US 2007/0098928 A1
(43) Pub. Date: May 3, 2007

(54) Calcium carbonate marking fluid receptors

(76) Inventors: Radha Sen, San Diego, CA (US); Richard J. Mcmanus, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/260,335

(22) Filed: Oct. 27, 2005

(51) Int. Cl. B41M 5/40

(52) U.S. Cl. 428/32.34

(57) ABSTRACT

The various embodiments involve marking fluid receptors, methods of their manufacture and use, and media produced using such receptors. Marking fluid receptive coatings of the various embodiments utilize calcium carbonate having controlled sizing of primary particles and their agglomeration.

### BACKGROUND

In a typical inkjet recording or printing system, droplets of marking fluid are ejected from a nozzle towards a recording substrate, or medium, to produce an image on the medium. The droplets generally include a marking material, such as one or more dyes or pigments, for marking the medium, and some aqueous or solvent-based carrier vehicle to facilitate controlled ejection of the marking material. The medium is generally coated with a receptor to aid binding of the marking material to the medium and to aid dissipation of the carrier vehicle to reduce the likelihood of smearing or bleeding of the wet marking fluid. Such receptors can be a significant factor in the cost and/or performance of the medium in reproducing a desired image.

### BRIEF DESCRIPTION OF THE DRAWINGS

FIGS. 1A-1C are micrographs of three example calcium carbonate feed materials for use with various embodiments of the disclosure.

FIGS. 2A-2C are micrographs of the feed materials of FIGS. 1A-1C, respectively, after milling in accordance with embodiments of the disclosure.

FIG. 3 is a cross sectional view of a print media in accordance with an embodiment of the disclosure.

FIG. 4 illustrates an imaging device for demonstrating another embodiment of the disclosure.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process, chemical or mechanical changes may be made without departing from the scope of the present disclosure. The following detailed description is, therefore, not to be taken in a limiting sense, and the scope of the present disclosure is defined by the appended claims and equivalents thereof.

The various embodiments involve marking fluid receptors, methods of their manufacture and use, and media produced using such receptors. The receptive coatings of the various embodiments utilize calcium carbonate (CaCO₃) having controlled sizing of primary particles and their agglomeration.

Pigments used in microporous marking fluid receptive coatings for photo printing at the current time generally include fumed silica and alumina, which produce a glossy and receptive coating, but are generally of high cost and can add significantly to the cost of the media. Prior attempts to produce lower cost high-gloss media have used precipitated calcium carbonate or ground calcium carbonate on a paper base, followed by the developing of gloss on the surface by using a casting drum or calendaring process. However, such glossed coatings are generally opaque and can lead to a washed out appearance with dye-based inks. The process of calendering also tends to close the open pore structure, thereby leading to slower absorption rates. The process of cast coating reduces the closing of the pores. However, the process of casting is also generally slow and difficult to control.

The various embodiments utilize calcium carbonate at controlled particle sizing and agglomeration to produce a generally transparent marking fluid receptor with high gloss characteristics. The embodiments can utilize commodity, low cost raw material and common dispersion processes to generate microporous coatings suitable for photo printing applications. The agglomerates form an open pore structure mimicking fumed silica or alumina and can be formulated with binders to form clear and glossy marking fluid receptive coatings.

The various embodiments are not generally dependent upon the grade of calcium carbonate utilized and were demonstrated using a variety of calcium carbonate feed materials, including both ground calcium carbonate (GCC) and precipitated calcium carbonate (PCC). The various embodiments were further demonstrated starting with both slurry and powder feeds. For one embodiment, the particle size of the incoming calcium carbonate feed material is ground to have primary particle sizing of approximately 10-30 nm forming agglomerates of approximately 50-200 nm. For a further embodiment, the agglomerates are formed by controlled surfactant depletion flocculation during the grinding process.

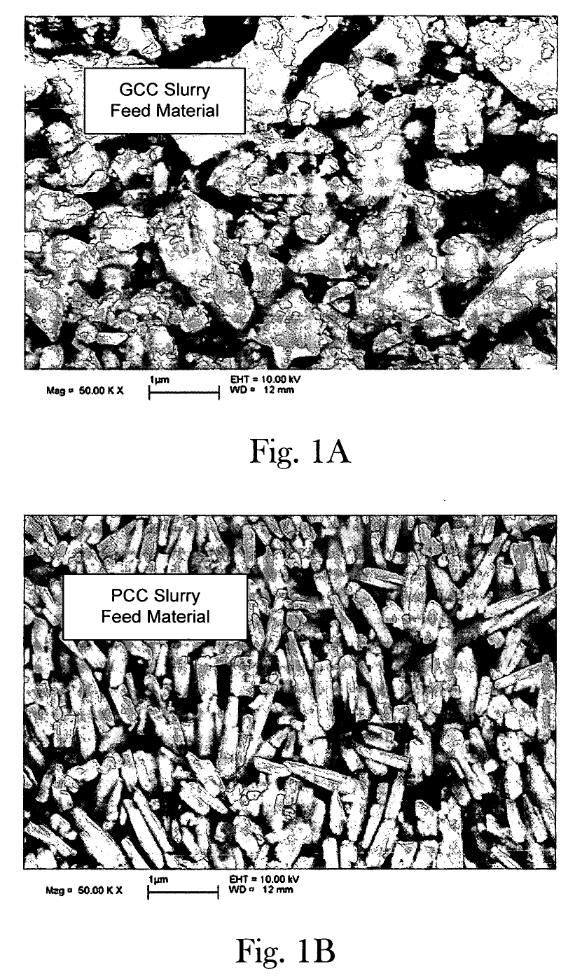

FIGS. 1A-1C are micrographs of three example calcium carbonate feed materials for use with various embodiments of the disclosure. Agglomerate particle size was measured using a laser scattering device such as a Microtrac® S3000, available through Microtrac, Inc., Montgomeryville, Pa., USA or a Horiba LA-900 available through HORIBA Instruments, Inc., Irvine, Calif., USA. Primary particle size was determined through the use of a scanning electron microscope (SEM). The particle size values discussed herein are based on the d50 measurements unless noted. A d50 measurement is an indication of a number median of a particle size distribution in that 50% of the particles would be expected to be smaller than the d50 measurement and 50% of the particles would be expected to be larger than the d50 measurement. FIG. 1A is a micrograph of a commercially-available GCC slurry material, Hydrocarb® 60, available through Omya, Inc., Proctor, Vt., USA. The material of FIG. 1A has a relatively large agglomerate particle size, on the order of 2 μm. FIG. 1 B is a micrograph of a commercially-available PCC slurry material, Opacarb® A40, available through Minerals Technologies Inc., New York, N.Y., USA. The material of FIG. 1 B has an elongated or needle-like structure compared to the GCC material. Due to this anisotropy, the d50 value of 0.32 μm is not reflective of the particles' true primary particle dimensions of approximately 1 μm long by 0.2 μm wide as shown by SEM. The material of FIG. 1C is a micrograph of a commercially-available PCC powder material, Multiflex-MM®, also available through Minerals Technologies Inc., New York, N.Y., USA. The material of FIG. 1C has an agglomerate particle size dimension of approximately 1.8 μm, though the primary particles are generally much smaller. Each of these materials, if used as received, would not result in a quality marking fluid receptor.

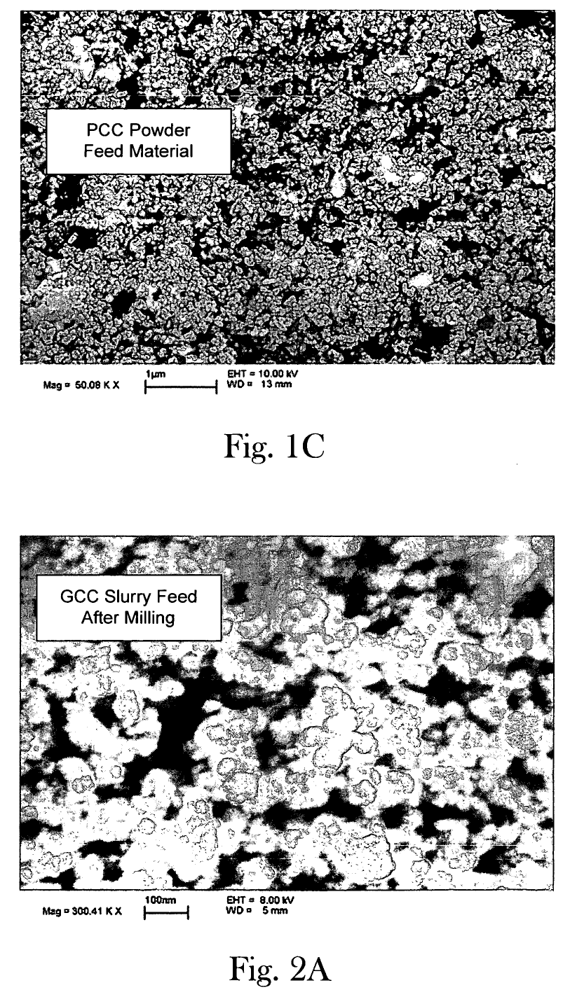

FIGS. 2A-2C are micrographs of the feed materials of FIGS. 1A-1C, respectively, after milling. Prior to milling, a slurry was formed of the PCC powder feed material of FIG. 1C. The material of FIG. 2A, the GCC slurry feed material after milling, shows a composite having small primary particles, of approximately 10 nm, forming larger agglomerates, of approximately 100 nm. The material of FIG. 2B, the PCC slurry feed material after milling, shows a composite having agglomerates up to about 120 nm, with particles down to about 20 nm. The material of FIG. 2C, the PCC powder feed material after forming a slurry and milling, shows a composite having agglomerates up to about 50 nm with particles down to about 1 0 nm. Each of the materials of FIGS. 2A-2C is capable of producing a glossy surface when coated on a substrate. In general, embodiments with lower agglomerate sizes will produce coated surfaces exhibiting higher gloss. However, packing of coated embodiments having lower agglomerate sizes can lead to a reduced propensity to absorb the carrier vehicle, thus increasing a likelihood of bleeding or running of the marking fluid.

To produce coating compositions in accordance with embodiments of the disclosure, the calcium carbonate feed material is milled to produce a distribution of particle sizes having a d50 value for primary particle size of less than about 50 nm. For some embodiments, the d50 value for primary particle size is in the range of approximately 10-30 nm. Coating compositions in accordance with embodiments of the disclosure further utilize controlled flocculation to form agglomerates of the primary particles. For some embodiments, the d50 value for particle size of the agglomerates is in the range of approximately 50-200 nm. Agglomerates of less than about 200 nm facilitate the production of transparent or translucent coating compositions, thereby providing a more desirable surface for receiving dye-based marking fluids and allowing the coating to be utilized on transparent substrates, such as overhead transparencies. Dyes absorbed into opaque receptive layers tend to appear washed out as the dye is absorbed into the opaque layer.

Tables 1A-1B contain data obtained from milling various calcium carbonate feed materials using a Lab Star Zeta™ bead mill available through NETZSCH-Feinmahltechnik GmbH, Selb, Germany. The design of the Zeta™ mill incorporates a central shaft with pegs to agitate the beads radially while the slurry is re-circulated through the mill axially. Tests were conducted using 0.2 mm and 0.1 mm YTZ (yttrium stabilized zirconium) beads using an anionic dispersant. Tables 2A-2B contain data obtained from milling various calcium carbonate feed materials using a QC100 disc mill available through Union Process Inc., Akron, Ohio, USA. The design of the QC100 mill incorporates a rotating disc to accelerate the beads and slurry toward a screen, where the slurry exits for re-circulation while the beads migrate back to the inlet of the rotating disc. Tests were conducted using 0.3 mm YTZ beads using an anionic dispersant. Each mill type produced similar results. Thus, it is expected that other milling processes could be utilized provided the particle sizes are achieved. Tables 1B and 2B include data for d50 values (Number Median) as well as Volume Median values for comparison.

TABLE 1A
Agitated Bead Mill

| | Batch | | Initial | Final | Initial | Final | Bead |
|---|---|---|---|---|---|---|---|
| Batch #/ | Size | | Solids | Solids | Surfactant | Surfactant | Size |
| Feed Material | (kg) | Surfactant | (%) | (%) | (%) | (%) | (mm) |
| #1 Hydrocarb ® 60 | 4.5 | Darvan ® C | 73 | 50.4 | 0.70 | 2.50 | 0.2 |
| #2 Hydrocarb ® 60 | 2 | Darvan ® C | 24.3 | 24.3 | 1.20 | 1.20 | 0.1 |
| #3 Multiflex-MM ® | 4.5 | Darvan ® C | 42.8 | 40 | 2.20 | 2.80 | 0.2 |
| #4 Multiflex-MM ® | 1.6 | Darvan ® C | 27 | 27 | 1.10 | 1.10 | 0.1 |
| #5 Multiflex-MM ® | 1.7 | Acumer ® 9300 | 26.4 | 26.4 | 1.76 | 3 | 0.1 |
| #6 Opacarb ® A40 | 4.5 | Darvan ® C | 43 | 43 | 0.00 | 1.60 | 0.2 |
| #7 Opacarb ® A40 | 1.6 | Acumer ® 9300 | 25.8 | 25 | 0.80 | 1.30 | 0.1 |

TABLE 1B
Agitated Bead Mill (continued)

| | | Final | Final Vol | Final Num | Grind |
|---|---|---|---|---|---|
| Batch #/ | Final | Temp | Median | Median | Time |
| Feed Material | Viscosity | (° C.) | (μm) | (μm) | (minutes) |
| #1 | 2060 cps | 50 | 0.193 | 0.107 | 120 |
| Hydrocarb ® 60 | | | | | |
| #2 | Fluid | 28 | 0.142 | 0.0907 | 270 |
| Hydrocarb ® 60 | | | | | |
| #3 | Paste | 60 | 0.138 | 0.073 | 180 |
| Multiflex-MM ® | | | | | |
| #4 | Paste | 27 | 0.128 | 0.0776 | 135 |
| Multiflex-MM ® | | | | | |
| #5 | 50 cps | 62 | 0.082 | 0.071 | 150 |
| Multiflex-MM ® | | | | | |
| #6 | 2124 cps | 58 | 0.174 | 0.076 | 90 |
| Opacarb ® A40 | | | | | |
| #7 | Paste | 31 | 0.1576 | 0.11 | 210 |
| Opacarb ® A40 | | | | | |

TABLE 2A
Rotating Disc Bead Mill

| | Batch | | Initial | Initial | Final | Bead |
|---|---|---|---|---|---|---|
| Batch #/ | Size | | Solids | Surfac- | Surfac- | Size |
| Feed Material | (kg) | Surfactant | (%) | tant (%) | tant (%) | (mm) |
| #1 Hydro- | 4 | Acumer ® | 40 | 1.00 | 12.50 | 0.3 |
| carb ® 60 | | 9300 | | | | |
| #2 Multi- | 4 | Acumer ® | 40 | 1.00 | 12.50 | 0.3 |
| flex-MM ® | | 9300 | | | | |

TABLE 2B
Rotating Disc Bead Mill (continued)

| | | Final | Final Vol | Final Num | Grind |
|---|---|---|---|---|---|
| Batch #/ | Final | Temp | Median | Median | Time |
| Feed Material | Viscosity | (° C.) | (μm) | (μm) | (minutes) |
| #1 | Paste | 60+ | 0.193 | 0.093 | 300 |
| Hydrocarb ® 60 | | | | | |
| #2 | Paste | 60+ | 0.126 | 0.08 | 180 |
| Multiflex-MM ® | | | | | |

The dispersants or surfactants utilized for the examples of Tables 1A-1B and 2A-2B are polyacrylate salt (Acumer® 9300) or polymethacrylate salt (Darvan® C) dispersants. Such polyelectrolyte dispersants have a high charge density and, therefore, have both charge and steric components of stabilization of the slurry flocculation. Other examples of suitable dispersants may include sodium tripolyphosphates. Darvan® C is available through R.T. Vanderbilt Company, Inc., Norwalk, Conn., USA. Acumer® 9300 is available through Rohm and Haas Company, Philadelphia, Pa., USA.

For some embodiments, the amount of surfactant is an amount not sufficient to satisfy the surfactant demand. In a milling process, as new surfaces are generated, surfactant may be added to the dispersion to reduce the interfacial energy of the solid/liquid interface or the energy of the system would increase and the particles would flocculate to reduce the energy of the system. Thus, surfactant is added to reduce the interfacial energy and also physically separate the particles to reduce flocculation. If there is sufficient surfactant to cover and keep the resultant particles separate, the surfactant demand of the system is met, otherwise, the surfactant demand is not met. Agglomeration due to reduced levels of surfactant frequently leads to increased viscosity. Surfactant may be added to a system to reduce the viscosity, but will generally only reduce the viscosity to some minima of the system. The surfactant level required for reaching the minima is the surfactant demand.

By maintaining the surfactant amount at some level below the demand, agglomeration and viscosity build is encouraged. For some embodiments, the slurries include surfactant at levels of approximately 2-5% of solids loading. For further embodiments, the slurries include surfactant at a level of approximately 3%. In this manner, the ground material will be flocculated during and after the milling process if all the surfactant is used up and no additional surfactant is available for stabilization. The floc size during the milling process is controlled by the size of the beads or other grinding media, which controls the number and area of contact. Depletion of surfactant during the milling cycle may also contribute to post-milling flocculation and the ultimate floc structure. Once the energy of milling is removed, if there is an insufficient amount of dispersant to meet demand, the particles will continue to agglomerate to reach an energy level minima.

Once milled, the calcium carbonate may be combined with binders for coating onto a substrate. Common binders for printing applications include polyurethane binders; latex binders, such as acrylates, methacrylics and methacrylates, styrene-butadiene copolymers and polyvinyl acetates, ethylene-polyvinylacetates and styrene-acrylic(acrylates, methacrylates, methacrylics) co-polymers and co-polymers thereof; and water-soluble binders, such as PVA, PVP, Cellulose, starch etc.

For one embodiment, a ratio of calcium carbonate dispersion to binder may be approximately 85:15 based on solids content of the dispersion. However, the ratio of dispersion to binder is not critical and may, for example, be in the range of 80:20 to 95:5. In general, lower binder content increases the likelihood of cracking of the resulting coating while higher binder content increases the resistance to penetration of the marking fluid.

The various embodiments may contain additives that do not materially affect the basic and novel properties of the dispersions disclosed herein. For example, coating compositions could further include coating aids, mordents and/or dye fixatives, as well as cross-linking agents when the binder used is cross-linkable. Further examples may include colorants, optical brighteners, defoamers, antifoams, plastic pigments, co-pigments such as silica, alumina, calcium carbonate, kaolin clay, titanium dioxide, calcined clay, aluminum trihydrate, barium sulfate, aluminum silicates, zinc oxide and/or talc.

The percent solids of the calcium carbonate dispersions in accordance with embodiments of the disclosure is generally a function of the capabilities of the milling equipment and the pigment water demand, but higher solids concentrations will facilitate improved coating efficiencies as lesser amounts of water or other carrier need to be removed after coating, thus allowing faster drying times and faster web speeds.

Coating compositions formed of the calcium carbonate dispersions in accordance with embodiments of the disclosure may be applied to a variety of substrates. For example, such coating compositions could be applied to paper bases, resin coated paper, or clear or opaque films. The coating compositions could be directly coated onto the substrate. Optionally, a base layer of some other composition could first be applied to the substrate and a coating composition in accordance with an embodiment of the disclosure could be coating onto the base layer. For example, paper substrates may benefit by such a base coating layer as it could lead to smoother top coatings, thus providing higher gloss. Examples of base layer coatings may include coatings having silica, alumina, calcium carbonate, kaolin clay, titanium dioxide, calcined clay, aluminum trihydrate, barium sulfate, aluminum silicates, zinc oxide and/or talc, combined with a binder and optional additives. Examples of binders and other components follow generally the same guidance as provided with binders and other components described in relation to embodiments of the disclosure.

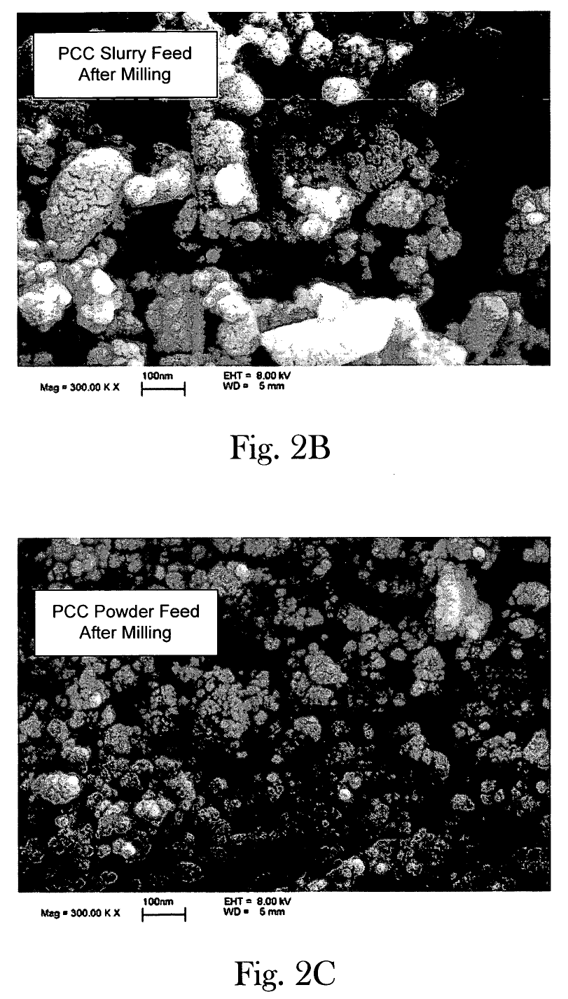

FIG. 3 is a cross sectional view of a print media 302 in accordance with an embodiment of the disclosure. The embodiment depicted in FIG. 3 includes a substrate 304, an optional overlying base coat layer 306 and an overlying calcium carbonate layer 308 in accordance with an embodiment of the disclosure. Substrate 304 may be any of a variety of substrates. Some examples of substrate 304 include paper, resin-coated paper or clear film. The optional base coat layer 306 is applied to a surface of the substrate 304. The calcium carbonate layer 308 in accordance with an embodiment of the disclosure is applied to a surface of the base coat layer 306. In the absence of the optional base coat layer 306, the calcium carbonate layer 308 would be applied to the surface of the substrate 304. Application of the optional base coat layer 306 and the calcium carbonate layer 308 may be performed using any of a variety of manufacturing techniques, such as, but not limited to, blade, rod, jet, airknife, roll, curtain and slot coating operations. Such coatings may be applied in a single layer, or may involve more than one layer of the coating material.

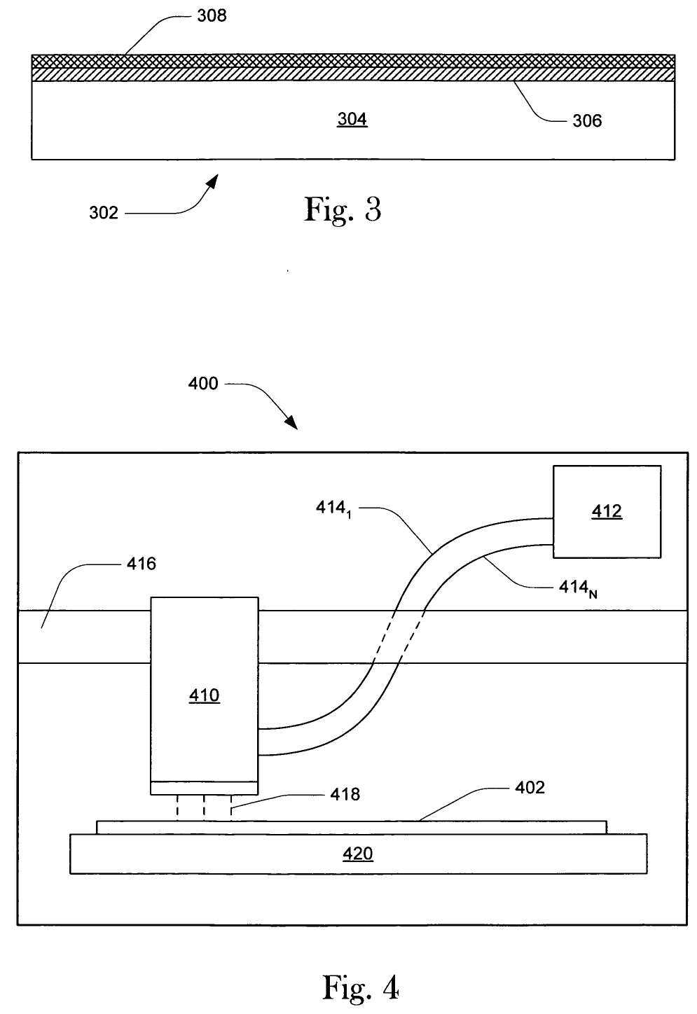

FIG. 4 illustrates an imaging device 400, such as an inkjet printer, for demonstrating another embodiment of the disclosure. Imaging device 400 has a fluid handling system that includes a fluid-ejection device 410, such as an inkjet print head, fluidly coupled to a marking fluid reservoir 412, e.g., an ink reservoir, by one or more conduits 414. Alternatively, the fluid-ejection device 410 may include an integral marking fluid reservoir without the need for an external supply, such as is common with inkjet pens. Fluid-ejection device 410 may be movably attached to a rail or other support 416, allowing it to move relative to the media 402. Fluid-ejection device 410 can eject marking fluid droplets 418, such as ink droplets, onto the media 402, as fluid-ejection device 410 moves across media 402. The media 402 includes a calcium carbonate coating in accordance with an embodiment of the disclosure. The media 402 may be stationary or movable on a support 420. Where the media 402 is movable, it typically travels in a direction orthogonal to the support 416 of the fluid-ejection device 410. As the droplets 418 are ejected onto the calcium carbonate coating of the media 402, an image is formed on a surface of the media 402.

What is claimed is:

1. A marking fluid receptive coating, comprising:
ground calcium carbonate;
wherein the ground calcium carbonate forms agglomerates having a d50 value for particle size of less than about 200 nm.

2. The marking fluid receptive coating of claim 1, wherein the agglomerates are formed of primary particles of calcium carbonate having a d50 value for particle size of less than about 50 nm.

3. The marking fluid receptive coating of claim 2, wherein the agglomerates have a d50 value for particle size in the range of about 50-200 nm and the primary particles have a d50 value for particle size in the range of about 10-30 nm.

4. A method of forming a marking fluid receptive coating composition, comprising:
milling a calcium carbonate feed material in a dispersion;
adding an amount of surfactant to the dispersion that is at a level less than a surfactant demand of the dispersion; and
combining the milled dispersion with a binder.

5. The method of claim 4, wherein milling a calcium carbonate feed material further comprises milling the calcium carbonate feed material to have a d50 value for primary particle size of less than approximately 50 nm.

6. The method of claim 4, wherein adding an amount of surfactant to the dispersion that is at a level less than a surfactant demand of the dispersion further comprises adding surfactant to the dispersion before and/or during the milling of the calcium carbonate feed material.

7. The method of claim 6, wherein adding an amount of surfactant to the dispersion that is at a level less than a surfactant demand of the dispersion further comprises adding an amount of surfactant in the range of about 2-5% of a solids content of the dispersion.

8. The method of claim 7, wherein adding an amount of surfactant to the dispersion that is at a level less than a surfactant demand of the dispersion further comprises adding surfactant to a level of about 3% of the solids content of the dispersion.

9. The method of claim 4, wherein adding an amount of surfactant to the dispersion that is at a level less than a surfactant demand of the dispersion further comprises adding an amount of surfactant sufficient to form agglomerates of calcium carbonate having a d50 value for agglomerate particle size of less than about 200 nm.

10. The method of claim 4, wherein adding an amount of surfactant to the dispersion that is at a level less than a surfactant demand of the dispersion further comprises adding an amount of surfactant sufficient to form agglomerates of calcium carbonate having a d50 value for agglomerate particle size in a range of from about 50 nm to about 200 nm.

11. The method of claim 9, wherein the agglomerates continue to form after milling of the dispersion is completed.

12. The method of claim 4, wherein adding an amount of surfactant to the dispersion further comprises adding an anionic surfactant.

13. The method of claim 12, wherein adding an anionic surfactant further comprises adding a polyelectrolyte dispersant.

14. The method of claim 4, wherein milling a calcium carbonate feed material further comprises milling a ground calcium carbonate feed material or a precipitated calcium carbonate feed material having either a slurry or a powder form.

15. A print media, comprising:
a substrate; and
a marking fluid receptive coating overlying the substrate;
wherein the marking fluid receptive coating comprises agglomerates of calcium carbonate having a d50 value for particle size of less than about 200 nm.

16. The print media of claim 15, wherein the agglomerates of the marking fluid receptive coating are formed of primary particles of calcium carbonate having a d50 value for particle size of less than about 50 nm.

17. The print media of claim 16, wherein the agglomerates of the marking fluid receptive coating have a d50 value for particle size in the range of about 50-200 nm and the primary particles have a d50 value for particle size in the range of about 10-30 nm.

18. The print media of claim 15, wherein the marking fluid receptive coating is overlying and adjoining the substrate.

19. The print media of claim 15, further comprising a base coat layer interposed between the marking fluid receptive coating and the substrate.

20. A method of producing a print media, comprising:
applying a marking fluid receptive coating overlying a substrate;
wherein the marking fluid receptive coating comprises calcium carbonate that has been ground in a dispersion containing an amount of surfactant that is not sufficient to satisfy a surfactant demand of the dispersion to form agglomerates having a d50 value for particle size of less than about 200 nm.

21. The method of claim 20, wherein the agglomerates having a d50 value for particle size of less than about 200 nm comprise primary particles of calcium carbonate having a d50 value for primary particle size of less than about 50 nm.

22. The method of claim 20, wherein the agglomerates having a d50 value for particle size of less than about 200 nm further have a d50 value for particle size greater than about 50 nm and wherein the agglomerates comprise primary particles of calcium carbonate having a d50 value for primary particle size in the range of about 10-30 nm.

23. The method of claim 20, further comprising applying one or more base coat layers on the substrate and applying the marking fluid receptive coating on the one or more base coat layers.

24. A method of using a print media, comprising:
ejecting a marking fluid onto a surface of the print media; and
absorbing at least a portion of the marking fluid into a coating of the surface, the coating comprising calcium carbonate agglomerates having a d50 value for particle size of less than about 200 nm.

25. The method of claim 24, wherein the agglomerates having a d50 value for particle size of less than about 200 nm comprise primary particles of calcium carbonate having a d50 value for primary particle size of less than about 50 nm.

26. The method of claim 24, wherein the agglomerates having a d50 value for particle size of less than about 200 nm further have a d50 value for particle size greater than about 50 nm.

27. The method of claim 26, wherein the agglomerates having a d50 value for particle size of less than about 200 nm and greater than about 50 nm comprise primary particles of calcium carbonate having a d50 value for primary particle size in the range of about 10-30 nm.
